(19) United States
(12) Patent Application Publication
(10) Pub. No.: US 2024/0419804 A1
(43) Pub. Date: Dec. 19, 2024

(54) SECURE PROMPT RECOMMENDATION USING REVERSE ENGINEERING SECURITY PROMPTS

(71) Applicant: MICROSOFT TECHNOLOGY LICENSING, LLC, Redmond, WA (US)

(72) Inventors: Mahan DAS, Mountain View, CA (US); Alexander David KLEIN, Seattle, WA (US)

(21) Appl. No.: 18/211,582

(22) Filed: Jun. 19, 2023

(51) Int. Cl. G06F 21/57; G06F 21/56

(52) U.S. Cl. CPC G06F 21/577; G06F 21/563; G06F 2221/033

(57) ABSTRACT

Disclosed are systems and methods for identifying prompts that cause a machine learning model to generate insecure code. A secure prompt that generates similar code, but without the security vulnerability, is proposed instead. In some configurations, a table of insecure prompts and corresponding secure prompts is pre-computed. Insecure prompts are generated by asking a code generation model for prompts that could have generated a piece of insecure code. A security analyzer confirms which of these potentially vulnerable prompts actually generate insecure code. A secure alternative to a potentially vulnerable prompt is create by asking the code generation model to identify a security vulnerability that an insecure prompt could generate. The code generation model is then asked to rewrite the potentially vulnerable prompt to not generate the security vulnerability. When an insecure user-supplied prompt is received, the table of insecure prompts is consulted to propose a secure alternative.

### BACKGROUND

Recent advancements in multimodal models for code generation have led to breakthroughs in several programming tasks. These models have successfully solved competition-level programming problems and are becoming an essential component in AI-assisted pair programming. Tools like GITHUB COPILOT have integrated seamlessly into daily programming workflows, with over a million developers leveraging them regularly.

Training data for these models is predominantly obtained from open-source repositories. However, the code stored in these repositories may contain software faults and security vulnerabilities. Code generated by models that were trained with insecure code may replicate the vulnerabilities.

Security vulnerabilities in model generated code may be subtle. Typical developers are just interested in solving a particular problem and are unlikely to perform a comprehensive security review to identify these vulnerabilities. Often, developers will copy and paste model generated code without any consideration of security vulnerabilities. Some developers will place misguided trust in code because it was generated by a model.

Insecure model-generated code may be added to the open-source projects that are used to train code generation models. This creates a vicious cycle of unwittingly propagating security vulnerabilities and other programming errors. Left unchecked, model generated code may come to contain more security vulnerabilities than hand-written code.

It is with respect to these and other considerations that the disclosure made herein is presented.

### SUMMARY

Disclosed are systems and methods for identifying prompts that cause a machine learning model to generate insecure code. A secure prompt that generates similar code, but without the security vulnerability, is proposed instead. In some configurations, a table of insecure prompts and corresponding secure prompts is pre-computed. Insecure prompts are generated by asking a code generation model for prompts that could have generated a piece of insecure code. A security analyzer confirms which of these potentially vulnerable prompts actually generate insecure code. A secure alternative to a potentially vulnerable prompt is create by asking the code generation model to identify a security vulnerability that an insecure prompt could generate. The code generation model is then asked to rewrite the potentially vulnerable prompt to not generate the security vulnerability. When an insecure user-supplied prompt is received, the table of insecure prompts is consulted to propose a secure alternative.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates a code generation model generating source code from a prompt.

FIG. 2 illustrates techniques for creating new prompts that potentially generate vulnerable code.

FIG. 3 illustrates confirming whether prompts generated by the prompt generator actually generate a security vulnerability.

FIG. 4 illustrates fixing vulnerable prompts.

FIG. 5 illustrates preventing a security vulnerability from being introduced into user code.

FIG. 6 is a flow diagram of an example method for secure prompt recommendation using reverse engineering security prompts.

FIG. 7 is a computer architecture diagram illustrating an illustrative computer hardware and software architecture for a computing system capable of implementing aspects of the techniques and technologies presented herein.

FIG. 8 is a diagram illustrating a distributed computing environment capable of implementing aspects of the techniques and technologies presented herein.

### DETAILED DESCRIPTION

Multimodal models represent a significant advancement in the field of machine learning. These models, with their increasing size, possess a vast learning capacity, enabling them to be applied to a wide range of tasks. They have demonstrated proficiency in areas such as text translation, summarization, chatbots like Chat-GPT, and even code generation and understanding. Notably, GITHUB COPILOT, an AI pair programmer built on OPENAI CODEX has gained popularity among developers, with over a million users. Models like CODEX, CODEGEN, and INCODER are trained on extensive collections of open-source code data, enabling them to generate code efficiently. With a textual prompt describing the desired functionality and the context of surrounding code, code generation models can produce appropriate code in multiple programming languages, automatically completing the code based on the provided context.

However, like other deep learning models, code generation models exhibit undesirable behavior in certain edge cases due to inherent properties of the model and the extensive, un-sanitized training data they are exposed to. For instance, CODEX is trained on unaltered source code obtained from GITHUB, inadvertently learning coding styles and, more critically, bugs that can potentially result in security vulnerabilities. Even minor modifications in the input text prompt can lead to software faults, which can pose risks if the generated code is used without alteration.

Below is an example of source code that has a subtle but serious security vulnerability on line 6:

| | |
|---|---|
| 1 | try { |
| 2 | class ExampleProtocol ( protocol.Protocol ): |
| 3 | def dataReceived (self, data ): |
| 4 | def confirmAuth (self, headers ): |
| 5 | try : |
| 6 | token = cPickle.loads ( base64.b64decode ( headers [‘AuthToken’])) |
| 7 | if not check_hmac ( token [‘signature’], |
| | token [‘data’ ], getSecretKey ( )): |
| 8 | raise AuthFail |
| 9 | self . secure_data = token [‘data’] |
| 10 | except : |
| 11 | raise AuthFail |
| 12 | } |

On line 6 the Pickle library is used to load data. However, a potential attacker can construct data that executes arbitrary code when loaded by the Pickle library. This behavior may be unexpected, but it is a real security vulnerability commonly found in code used to train machine learning models.

This vulnerability is an example of one of the Common Weaknesses Enumerations (CWEs). CWEs are a list of common software and system vulnerabilities. CWEs provide a standardized language to describe and categorize weaknesses, making it easier to identify, understand, and mitigate them. However, even if security vulnerabilities are categorized, there are always new types of security vulnerabilities being discovered. Furthermore, tools that identify known security vulnerabilities are not consistently applied. As a result, there is an ongoing stream of security vulnerabilities being inserted into source code that is used to train code generation models.

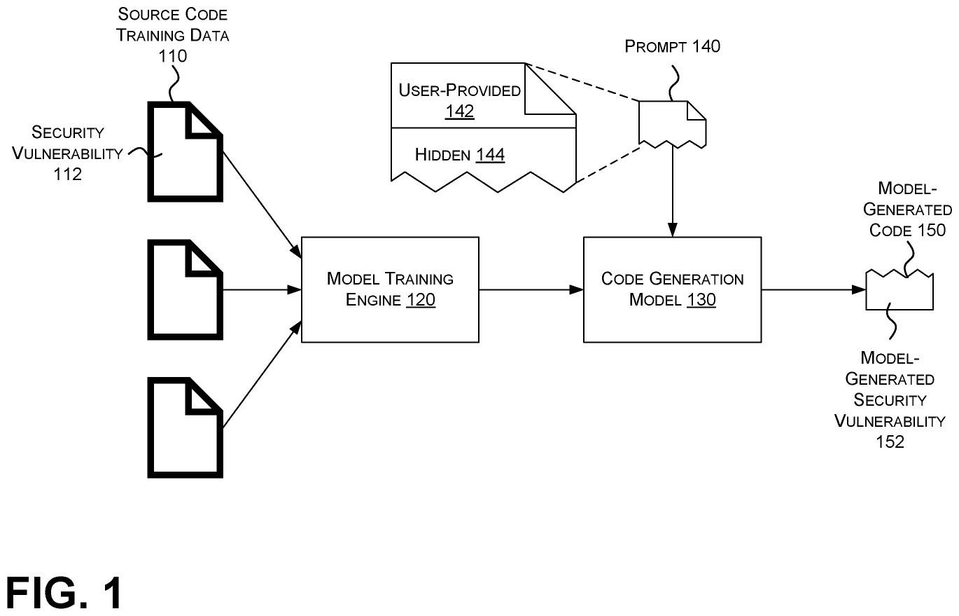

FIG. 1 illustrates code generation model 130 generating source code 150 from prompt 140. Code generation model 130 may be a multimodal model, although any type of machine learning model is similarly contemplated. Model training engine 120 uses source code training data 110 to generate code generation model 130. Source code training data 110 could be any type of source code file obtained from any number of repositories. For example, source code training data 110 may be written in different programming languages such as Python, C++, Visual Basic, etc. As discussed briefly above, source code training data 110 is often obtained from open-source code repositories such as GITHUB.

Source code training data 110 may include one or more errors such as security vulnerability 112. Throughout this document security vulnerabilities are often discussed as an example of a coding error, but any type of coding error is similarly contemplated, such as a segment fault, an out of memory condition, a logic error, an off-by-one error, or the like.

Model training engine 120 may use any known technique to train code generation model 130. Model training engine 120 may begin by preprocessing source code training data 110 to extract relevant features such as tokens, syntax structures, or semantic information. These features may be mapped to embeddings-vectors of numbers that represent the features. Model training engine 120 may then apply masked language modeling as part of a pre-training step to learn patterns between the features. The model is then trained on code that has been split in two pieces. One piece is provided as input to the model, which generates an output. A loss function compares the model output with the other piece of code. Gradient descent may then be applied to train the model based on the output of the loss function.

Prompt 140 may include source code, e.g., from a file that a user is editing. Prompt 140 may also include text provided by the user that makes an explicit or implicit request of code generation model 130. For example, a user might ask, via a chat interface, to “write me a function that downloads images from a search engine.” In some configurations the user request is obtained from text written within a source code file. For example, a function signature including function name and variable names may be the basis for prompt 140. Another source of prompt 140 from within a source code file is a comment. When taken from a source file, source code above and/or below the selected text may also be included in prompt 140.

In some configurations, prompt 140 contains a user-provided portion 142 and a hidden portion 144. User provided portion 142 may include source code up to a location in a source code file where generated source code will be inserted-often indicated by the insertion point caret or the mouse cursor. User provided portion 142 may also include a comment, function signature, or other user-generated text that is part of the source code. System portion 144 may be added to the user-provided portion 142 to cause code generation model 130 to yield a better result. For example, hidden portion 144 of prompt 140 may instruct model 130 that it should generate source code, and that it should generate source code in the programming language of user-provided portion 142. Hidden portion 144 may include many other considerations, including a preference for terseness or verbosity, a preference for iterative vs recursive algorithms, variable naming conventions, and any number of programming considerations.

Model 130 generates source code 150 based on prompt 140. Continuing the example, model 130 may generate code that downloads images from the search engine using the Pickle library. Model 130 may have a bias towards the Pickle library because it is frequently used in source code training data 110. In some cases model-generated code 150 will contain model-generated security vulnerability 152 which can be exploited using the same techniques as can be used to exploit security vulnerability 112.

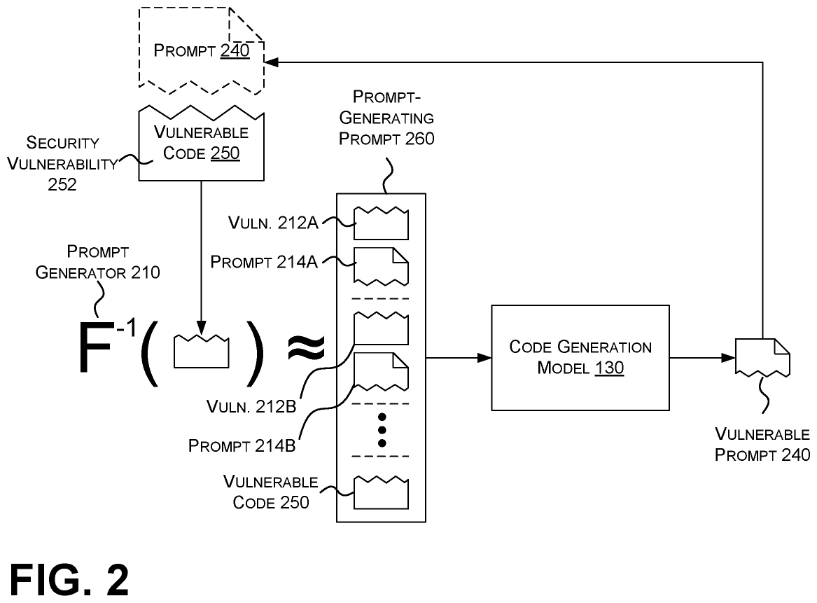

FIG. 2 illustrates techniques for creating prompts that generate vulnerable code. Prompt generator 210 accepts vulnerable code 250 as input and yields vulnerable prompt 240 as output. Vulnerable code 250 includes security vulnerability 252. Vulnerable code 250 may be part of a real-world application, or it may be a synthetic example of a common type of security vulnerability such as an example provided with a CWE. Vulnerable prompt 240 is a prompt that, when passed to code generation model 130, is likely to generate code with a security vulnerability similar to security vulnerability 252. Model-generated code based on vulnerable prompt 240 may not include an exact copy of security vulnerability 252 as it appeared in vulnerable code 250, but will tend to have some of the same control flow, usage patterns, and other attributes of security vulnerability 252 that make it vulnerable. In some circumstances, code generated from vulnerable prompt 240 will not have a security vulnerability comparable to security vulnerability 252.

Prompt generator 210 uses code generation model 130 to generate vulnerable prompt 240. Prompt generator 210 generates vulnerable prompt 240 by supplying prompt-generating prompt 260 to code generation model 130. Prompt-generating prompt 260 teaches code generation model 130 an association between source code vulnerabilities and prompts that generated them. Specifically, prompt-generating prompt 260 is constructed with a series of model-generated vulnerable source code snippets 212 and corresponding prompts 214 that were used to generate them. Vulnerable source code snippets 212 are provided before their corresponding prompts 214 so that model 130 will be prompted to produce a vulnerable prompt for vulnerable code 250. Specifically, vulnerable code 250 may be added to prompt-generating prompt 260 after the pairs of vulnerable code snippets 212 and corresponding prompts 214. Code generation model 130 then infers vulnerable prompt 240 by extrapolating the pattern of vulnerable source codes 212 and corresponding prompts 214 to vulnerable code 250.

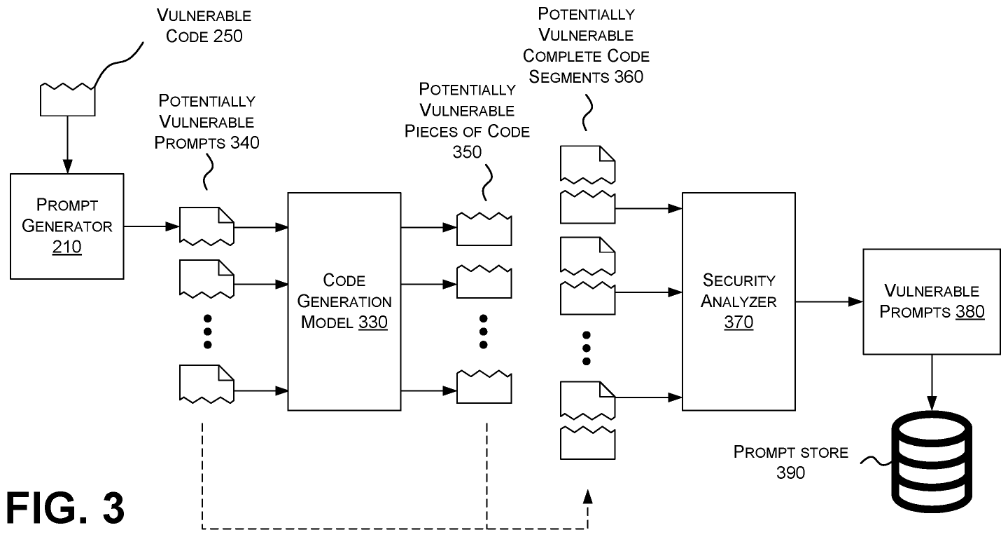

FIG. 3 illustrates confirming whether prompts generated by Prompt generator 210 do in fact generate a security vulnerability. Prompt generator 210 accepts vulnerable code 250 and generates potentially vulnerable prompts 340. Multiple potentially vulnerable prompts may be generated by invoking Prompt generator 210 multiple times. Additionally, or alternatively, Prompt generator 210 may be configured to generate multiple prompts for a given vulnerable code 250. For example, code-generation model 130 may be configured to return multiple outputs for a given prompt-generating prompt 260.

Some of potentially vulnerable prompts 340 will have security vulnerability 252 or equivalent. However, due to randomness inherent in machine learning models, or due to a failure of code generation model 130 to extrapolate the patterns of vulnerable code snippets 212 and corresponding prompts 214, some of potentially vulnerable prompts 340 will not cause security vulnerability 252 to be generated. In some configurations, actually vulnerable prompts 380 are identified from potentially vulnerable prompts 340.

To confirm whether prompts generated by Prompt generator 210 do in fact lead to code with security vulnerabilities, potentially vulnerable prompts 340 are provided as input to code generation model 330, yielding potentially vulnerable pieces of code 350. Potentially vulnerable pieces of code 350 are the kind of code snippets that may be suggested to a user. In some configurations, code generation model 330 is the same model as code generation model 130.

Potentially vulnerable prompts 340 are combined with corresponding potentially vulnerable pieces of code 350 to form potentially vulnerable complete code segments 360. In some configurations, each potentially vulnerable prompt 340 is combined with the potentially vulnerable code snippet 350 it produced. In this case, if there are N potentially vulnerable prompts 340, N potentially vulnerable complete code segments 360 will be generated. Additionally, or alternatively, copies of a particular potentially vulnerable prompt 340 are combined with different potentially vulnerable pieces of code 350, such that each potentially vulnerable prompt 340 will be part of up to N potentially vulnerable complete code segments 360. If every potentially vulnerable prompt 340 is combined with every potentially vulnerable code snippet 350, there will be N² potentially vulnerable complete code segments 360. Increasing the number of potentially vulnerable complete code segments 360 enables a more thorough exploration of whether a particular potentially vulnerable prompt 340 will cause insecure code to be generated.

Each of potentially vulnerable complete code segments 360 are source code that can be compiled or interpreted according to the language it is written in. Potentially vulnerable complete code segments 360 are analyzed by security analyzer 370 to determine if the code generated from potentially vulnerable prompts 340 does in fact contain a security vulnerability. These actually vulnerable prompts 380 are stored in prompt store 390. Potentially vulnerable prompts 340 that do not cause actually vulnerable code to be generated may be ignored or discarded.

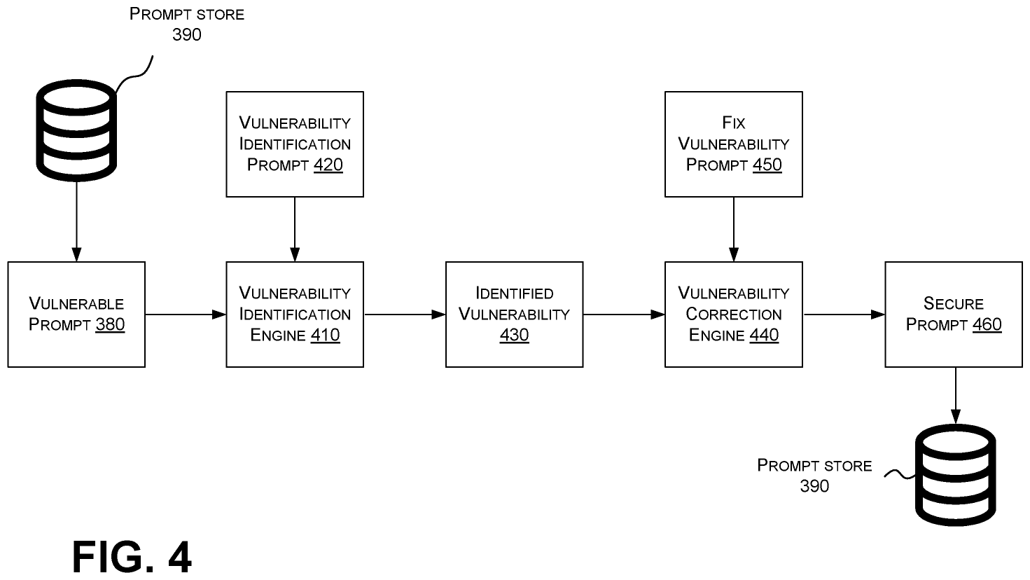

FIG. 4 illustrates fixing vulnerable prompts. Fixing in this context refers to creating a secure prompt 460 that generates code that performs the same function as code generated from a vulnerable prompt 380, but without the security vulnerability. In some configurations, actually vulnerable prompts 380 are fixed using reflection over code generation model 130. Reflection over a multimodal model such as code generation model 130 refers to prompting the same model to correct an error generated by that model. Reflection is most useful when it is applied to prompts that are known to be vulnerable, e.g., as determined by security analyzer 370. Reflection may still work, but is often less helpful when asking the model to find problems in a large number of prompts that may or may not generate security vulnerabilities.

In some configurations, vulnerability identification engine 410 is provided with vulnerable prompt 380 and vulnerability identification prompt 420. An example of vulnerability identification prompt 420 is “identify any security vulnerabilities that would be included in code generated by this prompt”. Vulnerability identification prompt 420 may be more or less specific, such as asking if the generated code will contain a particular type of vulnerability or whether there will be any errors in the generated code. Vulnerability identification engine 410 provides vulnerable prompt 380 in conjunction with vulnerability identification prompt 420 to code generation model 130, and then interprets the result. For example, vulnerability identification engine 410 may concatenate vulnerable prompt 380 to vulnerability identification prompt 420. If code generation model 130 finds identified vulnerability 430, the process continues. If code generation model 130 does not identify a vulnerability then vulnerability identification engine 410 may be run again with a different vulnerability identification prompt 420. In this way, code generation model 130 is utilized to anticipate vulnerabilities that could be generated by prompting code generation model 130 with vulnerable prompt 380.

Identified vulnerability 430 may then be provided to vulnerability correction engine 440 with fix vulnerability prompt 450. Fix vulnerability prompt 450 may say, for example, “please provide another prompt that generates code that performs the same functionality, but without the identified security vulnerability”. Fix vulnerability prompt 450 may include a text-based description of identified vulnerability 430. Fix vulnerability prompt 450 may also include vulnerable prompt 380. Vulnerability correction engine 440 provides fix vulnerability prompt 450, identified vulnerability, and/or vulnerable prompt 380 to code generation model 130, which returns secure prompt 460. For example, vulnerability correction engine 440 may concatenate vulnerable prompt 380 and/or identified vulnerability 430 to fix vulnerability prompt 450. Secure prompt 460, as produced by code generation model 130, may be used to prompt code generation model 130 to generate source code that provides similar functionality as source code generated from vulnerable prompt 380, but without the identified vulnerability 430.

Secure prompt 460 may be stored in prompt store 390. In some configurations, prompt store 390 maintains an association between secure prompt 460 and the vulnerable prompt 380 it was based on. In some configurations, code generation model 130 and security analyzer 370 are used to confirm that secure prompt 460 will not generate security vulnerability 252. For example, secure prompt 460 may be provided to code generation model 130, and the resulting code may be checked by security analyzer 370 to confirm that vulnerable code will not be generated.

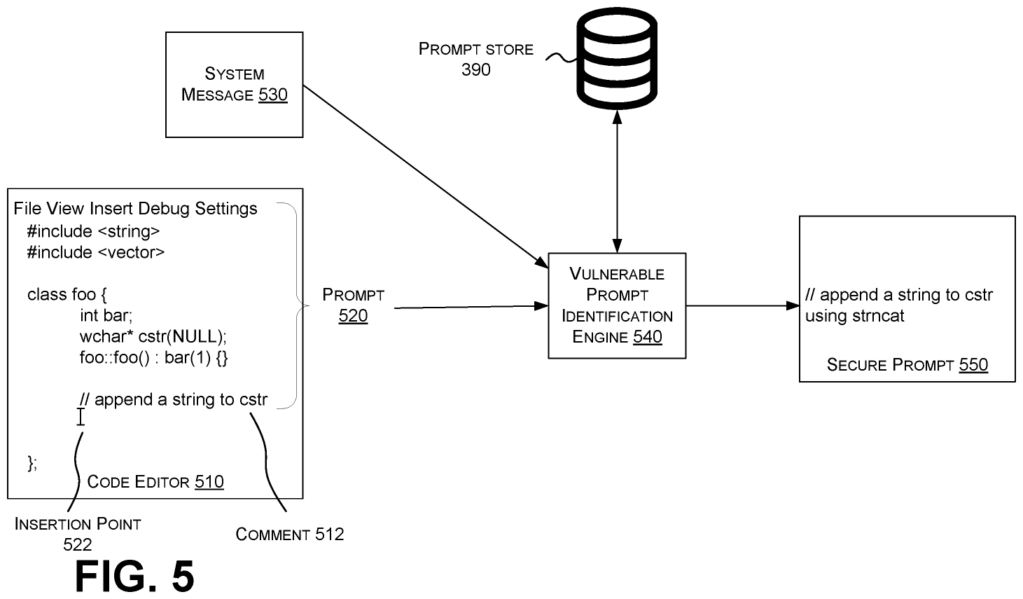

FIG. 5 illustrates preventing a security vulnerability from being introduced into user code. Specifically, a mapping from insecure prompts to secure prompts within prompt store 390 is consulted to suggest a more secure prompt before code with a security vulnerability is generated by code generation model 130.

Source code editor 510 has open a source code file that is being edited by a user. The user has entered comment 512, which describes a function that does not exist. Code generation model 130 may be employed in this scenario to create a function based on comment 512 and the surrounding context. However, in order to prevent the user from generating source code that includes a security vulnerability, vulnerable prompt identification engine 540 analyzes prompt 520, including system message 530, to determine if prompt 520 is likely to generate a security vulnerability. Vulnerable prompt identification engine 540 may make this determination by performing a string comparison of prompt 520 and vulnerable prompts 380 stored in prompt store 390. The string comparison may be a simple character by character comparison, an algorithm that computes the distance between two strings such as the Levenshtein distance, or the string comparison may be performed using a machine learning model, e.g., by comparing the distances of embedding vectors that represent prompt 520 and embedding vectors that represent vulnerable prompts 380 stored in prompt store 390.

If a match of prompt 520 is found in prompt store 390, a corresponding secure prompt 550 is retrieved from prompt store 390 and presented as an option to the user. In some configurations, secure prompt 550 may replace vulnerable prompt 380 without user intervention when using code generation model 130 to apply prompt 520.

Recommending secure prompts to a user has a number of benefits. First, it prevents code with security vulnerabilities from being inserted into a source code file. This intervenes in the process of writing insecure code as soon as possible-before the vulnerability is even written. Intervening at this early point in time minimizes the amount of time and effort it takes to identify and rectify a security vulnerability. Source code with a security vulnerability, whether it was generated by a code generation model or by hand, may not be caught until the code is tested, deployed, or used in the real world. At this point significant financial and reputational damage may be done to the entity that published the vulnerability. Preventing a security vulnerability as early as possible also minimizes the amount of time that developers spend writing, thinking about, and fixing code with security vulnerabilities.

Another benefit to identifying insecure prompts and suggesting secure alternative prompts is that the user is provided with assistance generating secure code. This is in contrast to detecting a security vulnerability with a source code analysis after the code has been generated. Identifying security vulnerabilities in source code after the fact is of benefit, but by this point in time the user has lost the chance to have the correct code automatically generated.

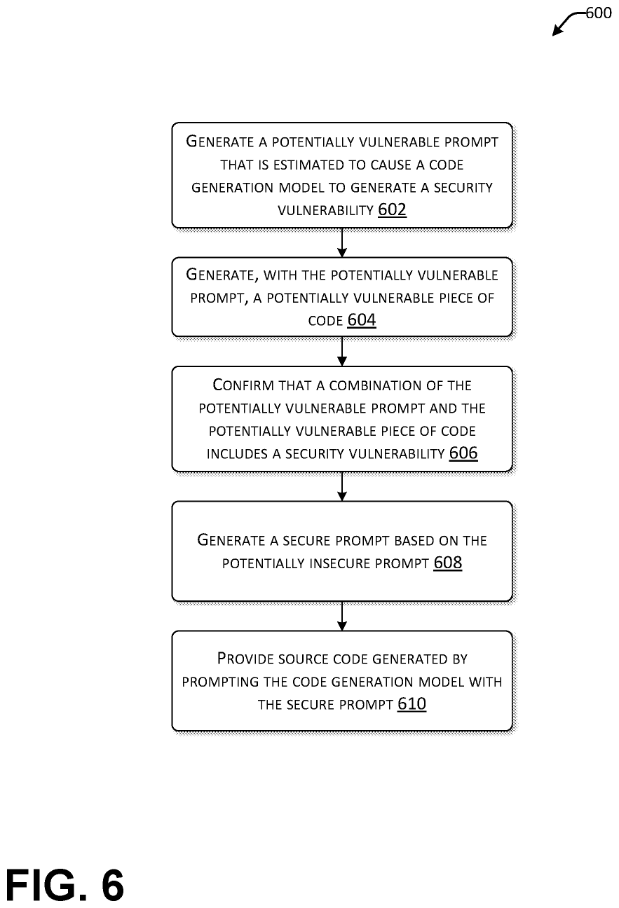

With reference to FIG. 6, routine 600 begins at operation 602, where a potentially vulnerable prompt 340 that is estimated to cause code generation model 130 to generate security vulnerability 252 is generated. In some configurations, multiple potentially vulnerable prompts 340 are generated for a particular piece of source code 250.

Next at operation 604, the potentially vulnerable prompt is provided to the code generation model 130 to generate potentially vulnerable piece of code 350. When multiple potentially vulnerable prompts 340 are generated then multiple corresponding potentially vulnerable pieces of code 350 are generated.

Next at operation 606, confirmation that potentially vulnerable complete code segments 360, which are created by appending potentially vulnerable prompts 340 and potentially vulnerable pieces of code 350, are confirmed as generating security vulnerability 252. In some configurations, security analyzer 370 is used to evaluated whether potentially vulnerable pieces of code 350 do create security vulnerability 252.

Next at operation 608, secure prompt 460 is generated based on potentially insecure prompt 340, as described above in conjunction with FIG. 4. In some configurations, reflection over code generation mode 130 is utilized, such as asking code generation model 130 what security vulnerabilities might be generated by potentially insecure prompt 340, and/or asking code generation model 130 to rewrite potentially insecure prompt 340 to not generate the identified security vulnerabilities 252.

Next at operation 610, source code generated from secure prompt 340 is provided to a user, e.g. into a source code file.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

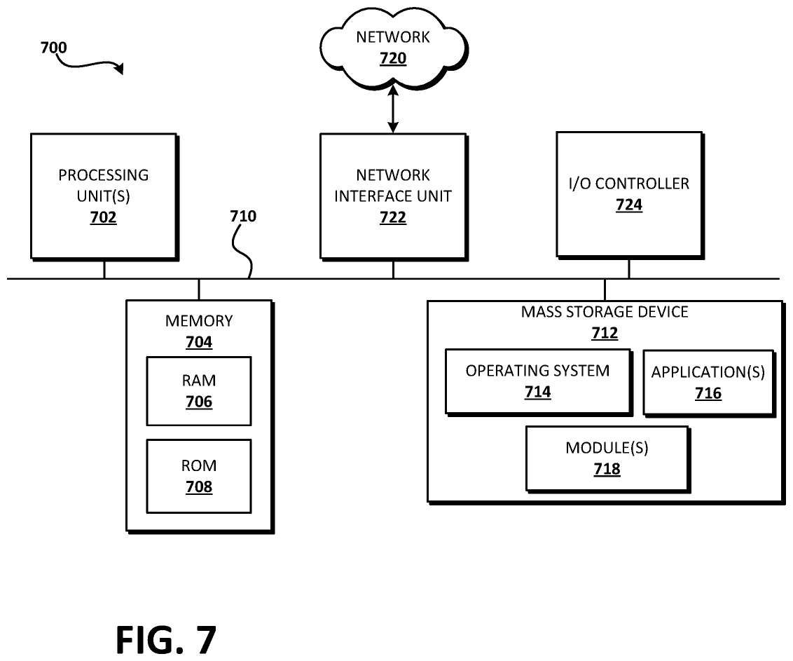

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

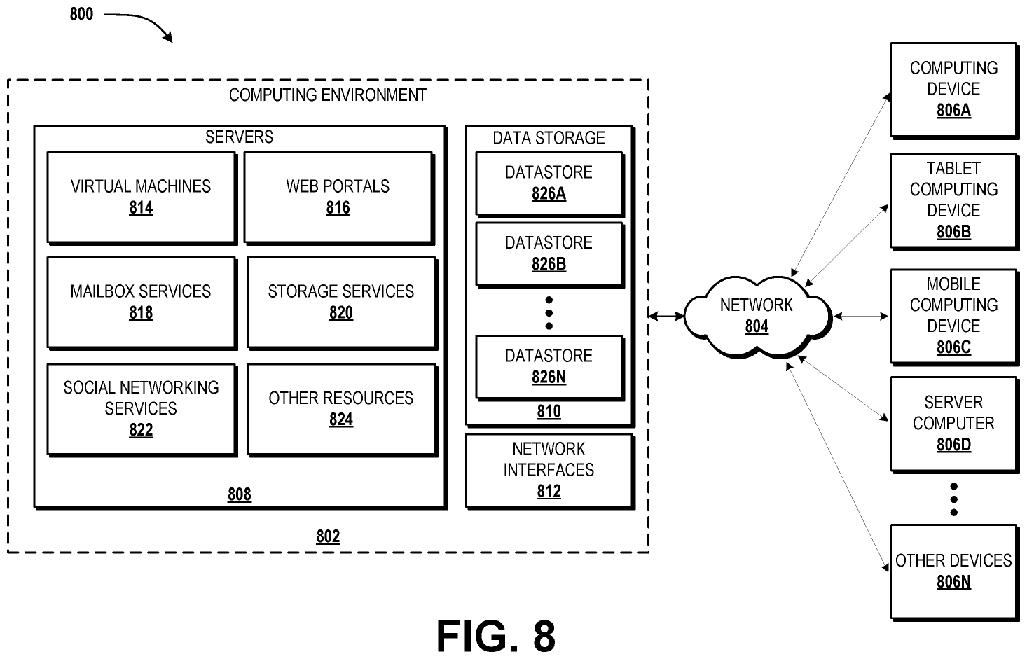

FIG. 8 depicts an illustrative distributed computing environment 800 capable of executing the software components described herein. Thus, the distributed computing environment 800 illustrated in FIG. 8 can be utilized to execute any aspects of the software components presented herein. For example, the distributed computing environment 800 can be utilized to execute aspects of the software components described herein.

Accordingly, the distributed computing environment 800 can include a computing environment 802 operating on, in communication with, or as part of the network 804. The network 804 can include various access networks. One or more client devices 806A-806N (hereinafter referred to collectively and/or generically as “clients 806” and also referred to herein as computing devices 806) can communicate with the computing environment 802 via the network 804. In one illustrated configuration, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802.

In various examples, the computing environment 802 includes servers 808, data storage 810, and one or more network interfaces 812. The servers 808 can host various services, virtual machines, portals, and/or other resources. In the illustrated configuration, the servers 808 host virtual machines 814, Web portals 816, mailbox services 818, storage services 820, and/or, social networking services 822. As shown in FIG. 8 the servers 808 also can host other services, applications, portals, and/or other resources (“other resources”) 824.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more servers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the servers 808 and/or other data. That is, the datastores 826 also can host or store web page documents, word documents, presentation documents, data structures, algorithms for execution by a recommendation engine, and/or other data utilized by any application program. Aspects of the datastores 826 may be associated with a service for storing files.

The computing environment 802 can communicate with, or be accessed by, the network interfaces 812. The network interfaces 812 can include various types of network hardware and software for supporting communications between two or more computing devices including, but not limited to, the computing devices and the servers. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 800 to utilize the functionality described herein for providing the techniques disclosed herein, among other aspects.

The present disclosure is supplemented by the following example clauses:

Example 1: A method comprising: receiving a potentially vulnerable prompt that is estimated to cause a code generation model to generate a security vulnerability; generating, with the potentially vulnerable prompt, a potentially vulnerable piece of code; receiving a confirmation that a combination of the potentially vulnerable prompt and the potentially vulnerable piece of code includes the security vulnerability; generating a secure prompt that generates source code that performs a same functionality as source code generated from the potentially vulnerable prompt without the security vulnerability; and providing source code generated by prompting the code generation model with the secure prompt.

Example 2: The method of Example 1, wherein the potentially vulnerable prompt comprises a plurality of potentially vulnerable prompts, wherein generating the potentially vulnerable piece of code comprises generating a plurality of potentially vulnerable pieces of code from the plurality of potentially vulnerable prompts, and wherein the confirmation that the combination of the potentially vulnerable prompt and the potentially vulnerable piece of code includes the security vulnerability comprises identifying combinations of the plurality of potentially vulnerable prompts and the plurality of potentially vulnerable pieces of code that cause the code generation model to generate the security vulnerability.

Example 3: The method of Example 2, wherein generating the secure prompt comprises generating secure prompts for the combinations of the plurality of potentially vulnerable prompts and the plurality of potentially vulnerable pieces of code.

Example 4: The method of Example 3, further comprising: storing mappings from the plurality of potentially vulnerable prompts to corresponding secure prompts.

Example 5: The method of Example 1, further comprising: receiving a prompt for generating source code; determining that the prompt for generating source code matches the potentially vulnerable prompt; and returning the secure prompt based on the determination that the prompt for generating source code matches the potentially vulnerable prompt.

Example 6: The method of Example 1, wherein the potentially vulnerable prompt is generated by providing the code generation model with a piece of code that includes the security vulnerability, pieces of vulnerable code, and prompts that caused the code generation model to generate the pieces of vulnerable code.

Example 7: The method of Example 6, wherein the potentially vulnerable prompt is generated by providing the code generation model with pairs of pieces of vulnerable code and corresponding prompts followed by the piece of code that includes the security vulnerability.

Example 8: The method of Example 1, wherein the combination of the potentially vulnerable prompt and the potentially vulnerable piece of code is confirmed to include the security vulnerability based on an analysis from a security analyzer.

Example 9: A system comprising: a processing unit; and a computer-readable storage medium having computer-executable instructions stored thereupon, which, when executed by the processing unit, cause the processing unit to: receive a potentially vulnerable prompt that is estimated to cause a code generation model to generate a security vulnerability; generate, with the potentially vulnerable prompt, a potentially vulnerable piece of code; receive a confirmation that a combination of the potentially vulnerable prompt and the potentially vulnerable piece of code includes the security vulnerability; generate a secure prompt that generates source code that performs a same functionality as source code generated from the potentially vulnerable prompt without the security vulnerability, wherein the secure prompt is generated by applying a reflection technique with the code generation model; and provide source code generated by prompting the code generation model with the secure prompt.

Example 10: The system of Example 9, wherein the reflection technique provides the code generation model with the potentially vulnerable prompt and a prompt to identify security vulnerabilities that would be generated by the potentially vulnerable prompt.

Example 11: The system of Example 10, wherein generating the secure prompt comprises providing the code generation model with a prompt to fix the potentially vulnerable prompt.

Example 12: The system of Example 11, wherein fixing the potentially vulnerable prompt comprises creating a prompt that generates a piece of source code without the security vulnerability that performs a same functionality as a piece of source code generated by the potentially vulnerable prompt.

Example 13: The system of Example 9, wherein the code generation model comprises a multimodal model trained on a corpus source code training data.

Example 14: The system of Example 13, wherein the source code training data contains the security vulnerability.

Example 15: The system of Example 9, wherein the potentially vulnerable prompt comprises a user-provided portion and a hidden portion.

Example 16: A computer-readable storage medium having encoded thereon computer-readable instructions that when executed by a processing unit causes a system to: receive a potentially vulnerable prompt that is estimated to cause a code generation model to generate a security vulnerability; generate, with the potentially vulnerable prompt, a potentially vulnerable piece of code; receive a confirmation that a combination of the potentially vulnerable prompt and the potentially vulnerable piece of code includes the security vulnerability; generate a secure prompt that generates source code that performs a same functionality as source code generated from the potentially vulnerable prompt without the security vulnerability, wherein the secure prompt is generated by prompting the code generation model to identify the security vulnerability in code that would be generated by the potentially vulnerable prompt and prompting the code generation model to create the secure prompt by creating a prompt that generates source code that performs the same functionality as source code generated from the potentially vulnerable prompt but does not generate the identified security vulnerability; and provide source code generated by prompting the code generation model with the secure prompt.

Example 17: The computer-readable storage medium of Example 16, wherein the instructions further cause the processing unit to: receive a user-supplied prompt; identify a potentially vulnerable prompt that matches the user-supplied prompt; and return a secure prompt that was created as an alternative to the potentially vulnerable prompt.

Example 18: The computer-readable storage medium of Example 17, wherein the user-supplied prompt comprises a portion of a source code file before a location in the source code file where the generated source code is inserted.

Example 19: The computer-readable storage medium of Example 17, wherein the user-supplied prompt matches the potentially vulnerable prompt based on a string comparison, a string distance algorithm, or a distance comparison of embeddings of the user-supplied prompt and the potentially vulnerable prompt generated by a machine learning model.

Example 20: The computer-readable storage medium of Example 16, wherein the potentially vulnerable prompt is combined with the potentially vulnerable piece of source code by appending the potentially vulnerable piece of source code to the potentially vulnerable prompt.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a potentially vulnerable prompt that is estimated to cause a code generation model to generate a security vulnerability;
generating, with the potentially vulnerable prompt, a potentially vulnerable piece of code;
receiving a confirmation that a combination of the potentially vulnerable prompt and the potentially vulnerable piece of code includes the security vulnerability;
generating a secure prompt that generates source code that performs a same functionality as source code generated from the potentially vulnerable prompt without the security vulnerability; and
providing source code generated by prompting the code generation model with the secure prompt.

2. The method of claim 1, wherein the potentially vulnerable prompt comprises a plurality of potentially vulnerable prompts, wherein generating the potentially vulnerable piece of code comprises generating a plurality of potentially vulnerable pieces of code from the plurality of potentially vulnerable prompts, and wherein the confirmation that the combination of the potentially vulnerable prompt and the potentially vulnerable piece of code includes the security vulnerability comprises identifying combinations of the plurality of potentially vulnerable prompts and the plurality of potentially vulnerable pieces of code that cause the code generation model to generate the security vulnerability.

3. The method of claim 2, wherein generating the secure prompt comprises generating secure prompts for the combinations of the plurality of potentially vulnerable prompts and the plurality of potentially vulnerable pieces of code.

4. The method of claim 3, further comprising:
storing mappings from the plurality of potentially vulnerable prompts to corresponding secure prompts.

5. The method of claim 1, further comprising:
receiving a prompt for generating source code;
determining that the prompt for generating source code matches the potentially vulnerable prompt; and
returning the secure prompt based on the determination that the prompt for generating source code matches the potentially vulnerable prompt.

6. The method of claim 1, wherein the potentially vulnerable prompt is generated by providing the code generation model with a piece of code that includes the security vulnerability, pieces of vulnerable code, and prompts that caused the code generation model to generate the pieces of vulnerable code.

7. The method of claim 6, wherein the potentially vulnerable prompt is generated by providing the code generation model with pairs of pieces of vulnerable code and corresponding prompts followed by the piece of code that includes the security vulnerability.

8. The method of claim 1, wherein the combination of the potentially vulnerable prompt and the potentially vulnerable piece of code is confirmed to include the security vulnerability based on an analysis from a security analyzer.

9. A system comprising:
a processing unit; and
a computer-readable storage medium having computer-executable instructions stored thereupon, which, when executed by the processing unit, cause the processing unit to:
receive a potentially vulnerable prompt that is estimated to cause a code generation model to generate a security vulnerability;
generate, with the potentially vulnerable prompt, a potentially vulnerable piece of code;
receive a confirmation that a combination of the potentially vulnerable prompt and the potentially vulnerable piece of code includes the security vulnerability;
generate a secure prompt that generates source code that performs a same functionality as source code generated from the potentially vulnerable prompt without the security vulnerability, wherein the secure prompt is generated by applying a reflection technique with the code generation model; and
provide source code generated by prompting the code generation model with the secure prompt.

10. The system of claim 9, wherein the reflection technique provides the code generation model with the potentially vulnerable prompt and a prompt to identify security vulnerabilities that would be generated by the potentially vulnerable prompt.

11. The system of claim 10, wherein generating the secure prompt comprises providing the code generation model with a prompt to fix the potentially vulnerable prompt.

12. The system of claim 11, wherein fixing the potentially vulnerable prompt comprises creating a prompt that generates a piece of source code without the security vulnerability that performs a same functionality as a piece of source code generated by the potentially vulnerable prompt.

13. The system of claim 9, wherein the code generation model comprises a multimodal model trained on a corpus source code training data.

14. The system of claim 13, wherein the source code training data contains the security vulnerability.

15. The system of claim 9, wherein the potentially vulnerable prompt comprises a user-provided portion and a hidden portion.

16. A computer-readable storage medium having encoded thereon computer-readable instructions that when executed by a processing unit causes a system to:
receive a potentially vulnerable prompt that is estimated to cause a code generation model to generate a security vulnerability;
generate, with the potentially vulnerable prompt, a potentially vulnerable piece of code;
receive a confirmation that a combination of the potentially vulnerable prompt and the potentially vulnerable piece of code includes the security vulnerability;
generate a secure prompt that generates source code that performs a same functionality as source code generated from the potentially vulnerable prompt without the security vulnerability, wherein the secure prompt is generated by prompting the code generation model to identify the security vulnerability in code that would be generated by the potentially vulnerable prompt and prompting the code generation model to create the secure prompt by creating a prompt that generates source code that performs the same functionality as source code generated from the potentially vulnerable prompt but does not generate the identified security vulnerability; and
provide source code generated by prompting the code generation model with the secure prompt.

17. The computer-readable storage medium of claim 16, wherein the instructions further cause the processing unit to:
receive a user-supplied prompt;
identify a potentially vulnerable prompt that matches the user-supplied prompt; and
return a secure prompt that was created as an alternative to the potentially vulnerable prompt.

18. The computer-readable storage medium of claim 17, wherein the user-supplied prompt comprises a portion of a source code file before a location in the source code file where the generated source code is inserted.

19. The computer-readable storage medium of claim 17, wherein the user-supplied prompt matches the potentially vulnerable prompt based on a string comparison, a string distance algorithm, or a distance comparison of embeddings of the user-supplied prompt and the potentially vulnerable prompt generated by a machine learning model.

20. The computer-readable storage medium of claim 16, wherein the potentially vulnerable prompt is combined with the potentially vulnerable piece of source code by appending the potentially vulnerable piece of source code to the potentially vulnerable prompt.
